(19) United States
(12) Patent Application Publication
(10) Pub. No.: US 2012/0107546 A1
(43) Pub. Date: May 3, 2012

(54) COULOMB DAMPING AND/OR VISCOUS DAMPING INSERT USING ULTRASONIC WELDING

(75) Inventors: James G. Schroth, Troy, MI (US); Thomas A. Perry, Bruce Township, MI (US); Mark T. Riefe, Brighton, MI (US)

(73) Assignee: GM GLOBAL TECHNOLOGY OPERATIONS, INC., Detroit, MI (US)

(21) Appl. No.: 12/913,867

(22) Filed: Oct. 28, 2010

(51) Int. Cl. F16F 7/00; B32B 15/00; B23K 20/10

(52) U.S. Cl. 428/76; 228/110.1

(57) ABSTRACT

One or more layers of vibration damping material are placed on one or more selected surface regions of a body portion of a vibratile metal article. The layer of damping material is covered with a thin metal sheet. The selected surface may be recessed in the body portion to receive the damping material. The covering sheet may be formed of the same metal composition as body portion, or of a compatible metal composition. The peripheral edges of the covering sheet are ultrasonically welded to the surface of the article body portion to confine the damping material against the selected surface(s) so that the damping material forms a vibration damping interface(s) with the surface(s) of the article. The damping material may function as a coulomb damping material, or a viscous damping material, or both.

### TECHNICAL FIELD

This invention pertains to methods of holding and confining a layer of vibration damping material against a selected surface area of a vibratile metal article to reduce mechanical vibrations generated by or transmitted in the article by effecting coulomb damping and/or viscous damping of at least the adjacent portion of the article. More specifically, one or more relatively thin layers of the vibration damping material are placed over the surface area, or in a suitable shallow recess in the surface area, and covered by an overlying sheet layer of suitable metal composition. The periphery of covering sheet layer is securely joined to the article surface by ultrasonic welding so that the covering layer confines the vibration damping material in interfacial contact with the surface area.

### BACKGROUND OF THE INVENTION

Automotive vehicle body structures, components, and propulsion devices are examples of many articles of manufacture that experience mechanical vibrations in their structure. The vibrations may, for example, occur in a wall or housing or partition structure, or in a shaft, or other structure susceptible to vibrating or passing vibrations. Often such operational or imposed vibrations are of a frequency that, if coupled with the surrounding atmosphere in a manner that makes them audible, can produce distressing noise to a user of the vehicle or other article. Further, vibrations in structures may lead to decreased fatigue life, if the amplitude, frequency, and mode structure are not controlled. Automotive vehicles have many body structures, motors, engine components, power transmission components, brakes, and the like that are designed to serve many functions in addition to operating at an acceptable vibrational or noise level. Still, there remains a need for practices of reducing vibrations and noise output from many such vibratile vehicle parts and other articles of manufacture.

At least in the case of automotive vehicles, such practices are needed both in the design of new vehicle parts for quiet operation and in the modification of existing vehicle parts for reduced broadcasting of noise and minimizing vibrational amplitude.

### SUMMARY OF THE INVENTION

A vibratile article of manufacture is often characterized by one or more shaped body portions and corresponding surface layers. In accordance with embodiments of the invention, a method is provided for incorporating one or more thin layers of unattached, but confined, vibration damping material on or within the body portion of a metallic article at or below a finished surface of the article. In some embodiments of the invention the vibration damping material may be in the form of one or more thin metal sheets or foils of a composition like that of the body of the article, or compatible with the body composition. The thickness of each such metal layer is suitably in the range of about 0.05 millimeters (50 micrometers) to about 0.5 millimeters (500 micrometers). In many embodiments the total thickness of the metal sheet or sheets will be from fifty micrometers up to about two thousand micrometers. Such sheets serve as coulomb dampers when they are in frictional engagement against an adjacent metal body surface. In other embodiments of the invention, the damping material may, for example, be thin layers of polymer material, which serve as viscous, energy absorbing layers that lie against a metal body surface and dampen vibrations originating in the adjacent body portion or being transported through it.

The layers of coulomb damping material are generally of uniform thickness and shaped to lie with their major surfaces in close contact with an adjacent body surface to provide interfacial contact for frictional vibration damping of the body portion. The layers of viscous damping material are generally of uniform thickness and shaped to lie with their major surfaces in close intimate contact with an adjacent body surface to provide vibration damping of the body portion. Typical viscous damping materials include rubber or rubberlike materials and polymers that exhibit strong hysteretic damping; that is, they form a large hysteresis loop in stress-strain space when deformed at a frequency of interest. Examples of such materials would include butyl rubber, neoprene, polyurethane, and other polymers, such as vinyls or nylons. The plan-view shape of the damping layer is designed to cover an area of the body to achieve a suitable interfacial vibration damping effect. Where two or more layers of damping materials are applied to a body portion, both layers may be used to achieve coulomb damping or viscous damping or a combination of both damping mechanisms. The thickness of the viscous damping material will usually be in the range of about twenty-five micrometers to about one thousand micrometers.

In some embodiments of the invention the layer(s) of damping material is applied to an unaltered surface of the body portion, or into a shallow recess formed in the surface for the purpose of receiving the damping material. It is generally preferred to provide a shallow recess in the body surface that is shaped or configured to receive and laterally confine the one or more layers of vibration damping material. The inserted damping material, placed in the recess, may lie flush-with or above the surrounding surface of the body. In most embodiments of the invention, a recess having a depth up to about one thousand micrometers and less than the total thickness of the vibration damping material will be suitable. In each such embodiment a thin metal sheet is placed over the vibration damping material so as to confine it in interfacial contact with the underlying surface. The periphery of the metal cover sheet is ultrasonically welded to the surrounding surface of the metal body of the article. In each embodiment, the layer of damping material is entirely covered with a thin sheet of metal, preferably of the same composition as the adjoining body of the article. The shape of the covering metal sheet is such that it may be ultrasonically welded around its entire periphery to trap and contain the vibration damping layer in interfacial contact against the body portion of the article. In most embodiments a thickness of the covering metal sheet of up to about three hundred micrometers will be suitable.

In some embodiments of the invention the vibration damping material may be introduced into an unfinished body portion of the article as the body portion is being made. In other embodiments of the invention, some part of a previously-made body portion may be adapted for placement and covering of vibration damping material by methods of this invention. The surface of the body portion or layer within the body portion may be substantially flat or contoured. After the layer or layers of damping material have been confined on or within the body portion of the article by ultrasonic welding of the covering metal layer, the surface of the article may be finished in any desired manner for the appearance, use, and performance of the article.

The selection of the damping material or materials and the locations of the materials in or on the body of the article are determined by trial or experience to provide a desired vibration damping effect in a vibratile article of manufacture.

Other objects and advantages of the invention will be apparent from a description of illustrative examples which follow below in this specification. The examples are intended for illustration of practices of the invention but not as limitations on the scope of the invention.

### BRIEF DESCRIPTION OF THE DRAWINGS

FIG. 1A is a schematic illustration of a fragment of a body portion illustrating a shallow square recess formed or provided in a surface of the body portion. FIGS. 1B-1D are also schematic, fragmentary illustrations of, respectively, a placed insert of vibration damping material (1B), the placement of a metal cover sheet over the inserted damping material (1C), and the cover sheet as an ultrasonic weld is being formed around the entire periphery of the cover sheet (1D).

FIG. 2A is a cross-sectional, side elevation view of the fragment of the body portion of FIG. 1A showing the recess in the body portion. FIGS. 2B-2D are also cross-sections of FIGS. 1B-1D illustrating, respectively, an insert of vibration damping sheet material in the recess (2B), the placement of a metallic cover sheet over the insert of vibration damping material (2C), and a sonotrode roller forming an ultrasonic weld band between the periphery of the cover sheet and the underlying body portion, confining the vibration damping insert material in the recess of the body portion (2D).

FIG. 3 is a cross-sectional, side elevation view of a fragment of a body portion where a layer of vibration damping material is placed on an unaltered surface of a body portion of an article and covered with thin metal sheet. The peripheral edges of the sheet are being ultrasonically welded with a sonotrode roller to the surface of the body portion.

### DESCRIPTION OF PREFERRED EMBODIMENTS

Embodiments of this invention are useful in damping vibrations in articles of manufacture having one or more metallic portions or structural elements in which mechanical vibrations are produced or transmitted. Many such vibratile articles are used, for example, in automotive vehicles. The article may have at least one structural element which is formed of a metal composition such as an aluminum alloy, a steel alloy, a magnesium alloy, or other metal alloy composition. Since an automotive vehicle comprises many parts and components and is intended to be used in motion, many such components are subjected to, or are susceptible to fatigue-causing and/or noise-making vibrations.

Practices of the invention will be illustrated as applied to at least one structural element of an article, such as a metal housing for an electronic device for controlling the operation of an electric motor for driving one or more wheels of a vehicle. For example, such a housing component may be die cast from an aluminum casting alloy, such as alloy 380.

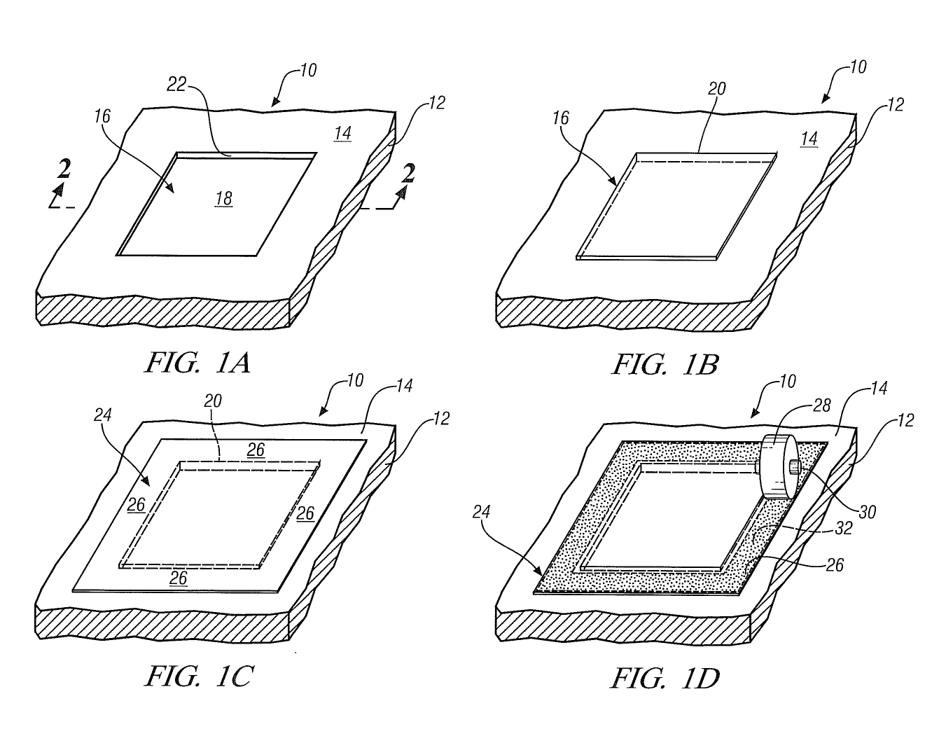

FIG. 1A is a schematic illustration of a broken-away portion of a metallic article 10 such as a housing component for a power electronics device. Article 10 has a body portion 12 (only a part of which is illustrated in the drawing figures) with a surface 14. Surface 14 is simply illustrated as flat, but practices of the invention are applicable to contoured surfaces.

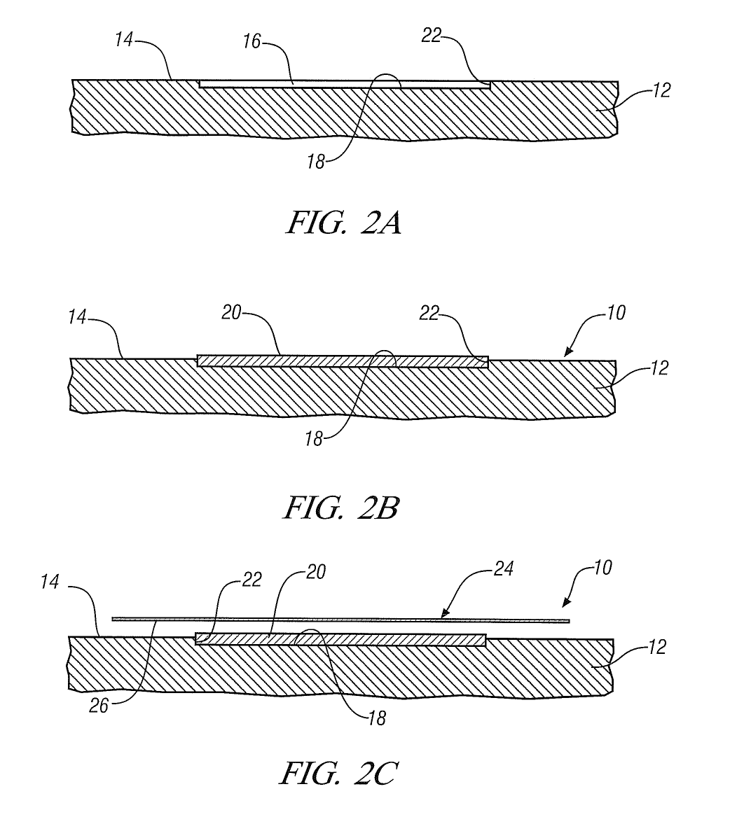

FIG. 2A is a cross-sectional view taken along section line 2-2 of FIG. 1A. And FIGS. 2B-2D are cross-sectional views that are complementary to the oblique views of FIGS. 1B-1D in illustrating practices of the invention.

The design of article 10 has taken into consideration that it may generate or transfer mechanical vibrations as it is being used in its location on a vehicle. Further the structure and shape of the article have been tested and/or analyzed to identify a region of the article in which such vibrations might be damped by application of thin layers of suitable damping materials to one or more surfaces 14 of a body portion. In some embodiments of the invention, it is suitable to apply a layer of damping material directly to a region of a surface 14. However, it is often preferred to provide a strategically-located, receptacle volume or recess in the body portion to better confine the vibration damping material.

As a result of such determinations and in this illustrative embodiment, a shallow recess 16 has been formed in surface 14. In FIG. 1A, recess 16 is illustrated as square with a flat bottom surface 18, but such recesses may be formed in any plan-view configuration depending on the shape and available area for vibration damping in a particular article. The depth of recess 16 is exaggerated for visibility in the drawing figures. A representative recess 16 is typically only about 100-1000 micrometers deep. Such recesses may be formed in a body portion 12 of article 10 as that portion of the article, including surrounding surface 14, is being made in the first instance. Alternatively, such a recess 16 may be machined into surface 14 at an appropriate stage of manufacture of the article 10.

The outline of recess 16 and the dimension(s) of its walls 22 are predetermined to receive one or more layers 20 of vibration damping material. In FIG. 1B, a single layer of vibration damping material 20 has been placed in recess 16. In the illustrative embodiment of FIG. 1B, the vibration damping material 20 is a metal sheet or foil having a thickness that is more than the height dimension of the walls 22 of recess 16 and the top of layer 20 extends slightly above the surrounding surface 14 of body portion 12 of article 10. For example, the composition of damping material 20 may be the same as the metal alloy of which body portion 12 is made. In other examples, the composition may be different than the body portion alloy, but chemically compatible with the composition of the body portion 12. Further, and by way of example, the thickness of sheet metal damping material may be about 800 micrometers and the height of side wall 22 smaller.

In FIG. 2B, it is easier to see that the thickness of the sheet metal damping material 20 is slightly greater than the height of side walls 22 of recess 16. In some practices of the invention, it is desired to have the vibration damping material extend above the side walls of a recess so that when a covering sheet is applied, the damping material is pressed in close interfacial contact against the bottom surface 18 of recess 16.

In still other embodiments of the invention, the total thicknesses of one or more layers of vibration damping material may be substantially the same as the height of walls 22. And, as stated, one or more layers of vibration material may be inserted in a recess 16 or on a surface 14 of body portion 12.

In some embodiments of the invention, the coulomb damping materials consist of a stack of layers that are each about 50 to about 500 micrometers in thickness. And depending on how many layers of damping material are placed in a recess 16 (or directly on a surface 14) the depth of a recess, as measured by side walls 22, is up to several hundred micrometers or so.

In other embodiments of the invention, coulomb damping material consists of a single layer that is about 50 to about 2000 micrometers in thickness. Viscous damping material may suitably consist of a single layer that is about 25 to about 1000 micrometers in thickness.

As illustrated in FIGS. 1C and 2C, a metal sheet 24 or foil is placed onto surface 14 of body portion 12 of article 10 so as to fully cover the damping material 20 placed in recess 16. Metal sheet 24 is preferably formed of the same metal composition as body portion 12. However, metal sheet 24 may be of any metal composition that is compatible with the metal composition of body portion 12 and its surface 14. Metal sheet 24 is shaped to fully cover and enclose the damping material 20 placed in recess 16. A suitable area of the periphery or peripheral edges 26 of metal sheet 24 lies on surface 14 surrounding recess 16 as illustrated in FIGS. 1C and 2C. In the illustrative embodiment of the invention presented in FIGS. 1A-1C and 2A-2C, the recess 16 is square and metal sheet 24 is also square. The peripheral edges 26 of metal sheet 24 that lie on surface 14 around recess 16 are in the shape of four rectangular bands. Of course, in other embodiments of the invention, as applied to other articles, the shapes of recesses and covering metal sheets may take any necessary configuration or shape. The thickness of metal sheet is determined as suitable for confining damping material 20 against surface 18 of recess 16. In many embodiments of the invention, the thickness of metal sheet 24 will be in the range of about 100-300 micrometers. The peripheral edges 26 of covering metal sheet 24 are then ultrasonically welded to surface 14 surrounding recess 16 and damping material 20.

In accordance with practices of this invention ultrasonic welding is used to bond peripheral portions of a thin metal sheet, strip, foil, or tape to a surface of a metal article or portion of an article so as to confine vibration damping material against a surface of the article. When this welding process is applied to bond a vibration material-covering metal sheet layer to a surface of a metal article, a true metallurgical bond is created over the interface, although no liquid (molten) metal is involved. The ultrasonic consolidation of the metal-metal interface occurs in a solid (non-molten) state environment.

The temperature rise at the interface between the covering layer and the surface of the metal article is below the melting point, typically 35% to 50% of the absolute value of the melting point for most metals, and any heating that occurs is confined to a region a few microns thick. Rapid heat dissipation from the region of bonding ensures that minimal residual stresses arise. As such, post-processing to relieve residual stresses is typically not necessary. Similarly, phase transformation is generally avoided.

The main components of an ultrasonic welding unit are well known and commercially available. An ultrasonic generator or power supply receives main grid electricity at a low frequency, preferably in the range of 50 to 60 Hz, and at a low voltage of 120V or 240V AC. The generator converts the input to an output at a higher voltage, preferably having a frequency in the range of 15 to 60 kHz. A useful working frequency is 20 kHz, which is above the normal range of human hearing of about 18 kHz. Systems employing higher frequencies of 40 kHz to 60 kHz with lower amplitude vibrations are preferably employed for fragile materials, such as very thin foils or substrates which are easily damaged.

The high frequency output of the ultrasonic generator is transmitted to a transducer or converter, which converts the signal to mechanical vibratory energy at the same ultrasonic frequencies. State-of-the art transducers operate on piezoelectric principles and incorporate discs or rings made of piezoelectric material, such as piezoelectric ceramic crystals, which are compressed between two metal sections. An advanced generator features automatic tuning adjustment in relation to the transducer so that constant amplitude of vibration is maintained during the operation of the welding unit.

The vibratory energy of the transducer is transmitted to a booster, which decreases or increases the amplitude of the ultrasonic waves. The waves are then transmitted to the sonotrode (also called a horn), which is a custom-made tool that comes in contact with the workpieces. The sonotrode may be designed as a tool-holder carrying a tool bit, or it may be provided in one integrated piece incorporating specific geometric features. In many embodiments for application of a tape, foil, or strip to a surface of an article, the sonotrode may be formed as a roller with axles for rolling contact with the upper surface of the strip.

In the embodiment of FIGS. 1D and 2D, a sonotrode 28 is illustrated schematically in the form of a roller with its axle 30 as it engages the surfaces of the peripheral edges 26 of cover sheet 24. Sonotrode roller 28 progressively rolls over peripheral edges 26, pressing them against underlying surface 14 of body portion 12, to form a coextensive weld bond 32 between the peripheral edges 26 and underlying portions of surface 14. The ultrasonic vibrations are transmitted axially with respect to the roller axis of sonotrode 28. For ultrasonic welding of metals the sonotrode is preferably made of tool steel and it may be manufactured as a unitary component. This ultrasonic welding step joins the peripheral edges 26 of cover sheet 24 to body portion 12 in a square weld pattern so as to trap and confine damping material layer(s) within recess 16 and in vibration damping contact with recess bottom surface 18 on body portion 12.

The methods illustrated in FIGS. 1A-1D and 2A-2D may be used in one or more selected locations on an article for vibration damping. Depending on the nature and requirements of a particular article, thus provided with vibration damping, the cover sheet used to trap the damping material may itself be covered, coated, painted, or otherwise incorporated into the body or surface or the article.

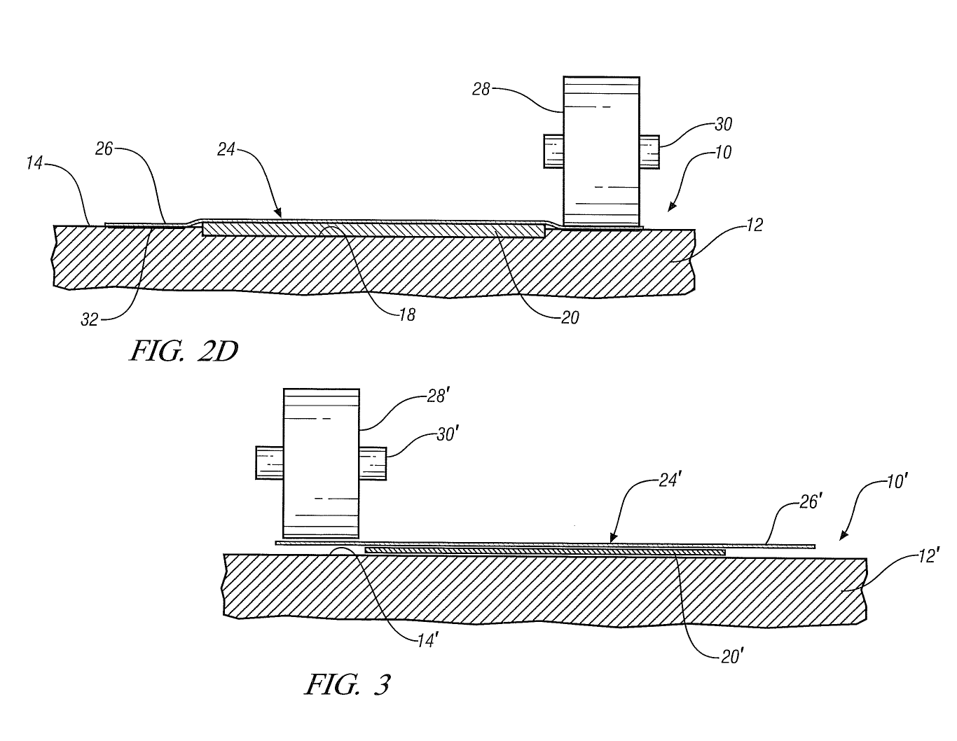

In the above illustrations of practices of the invention, one or more layers of damping material were confined within a recess formed in a body portion of the article. In other embodiments of the invention, one or more layers of damping material may be covered and confined against a surface of an article without the use of a formed recess. For example, as illustrated in FIG. 3 (with the respective members spaced apart for easier visualization), a suitably shaped, thin layer of vibration damping material 20′ may be placed at a selected location on a surface 14′ of an article 10′. In FIG. 3, damping material layer 20′ is shown spaced slightly above surface 14′ for visualization. But damping material 20′ would be placed directly against a region of surface 14′. Cover sheet 24′ with its peripheral edges 26′ is placed directly over damping material 20′ confining the damping material 20′ against surface 14′. The peripheral edges 26′ of cover sheet 24′ are then ultrasonically welded to surface 14′ using sonotrode roller 28′, as described above in this specification.

An example of application of this invention may be to a portion of a power electronics housing as used to contain the power inverter module for a hybrid electric automobile. Such housings may be die cast from a suitable alloy such as aluminum casting alloy 380. The recess may be machined into an inner surface of the housing with damping material positioned within the recess but extending above the electronic component of the housing. A cover sheet would be subsequently welded around its periphery to trap the damping material between the sheet and the casting. In the case of the power electronics housing , the damping treatment is placed on the inside surface of the housing such that once the housing is assembled, the added materials are not visible and they are not exposed to the environment, but rather lie within a sealed enclosure.

In the use of an article made in accordance with this invention, the covered and trapped vibration damping material engages a surface of the article in vibration damping interfacial contact. Where the vibration damping material is a metal sheet or layer, or other non-viscous material, the interfacial contact is frictional and coulomb damping occurs to absorb energy of the vibrations and to mitigate their intensity and effect. Where the vibration damping material is viscous, such as a polymeric material, the damping effect is of a viscous mechanism and nature.

Thus, practices of the invention have been described by some illustrative examples. But the invention is clearly applicable to the incorporation of one or more thin layers of vibration damping material to variously shaped surfaces of many different shapes of metal articles.

1. A method of making an article of manufacture comprising one or more structural elements in which at least one of its structural elements is found or determined to produce or transmit mechanical vibrations in use of the article, the vibratile structural element being made of a metallic composition; the method comprising:
making at least a first portion of the vibratile element structure, the first portion having at least one surface area, or recessed surface area, selected for damping of mechanical vibrations in the article, each such surface area being circumscribed by a surrounding surface of the first portion of the vibratile element structure;
applying at least one layer of vibration damping material over the selected surface area or into the recessed surface area, the composition of the vibration damping material being selected for coulomb damping or viscous damping of the surface area in use of the article;
covering the layer of vibration damping material with a sheet metal layer, the sheet metal covering-layer having a shape with a periphery for bonding to the surrounding surface of the first portion, and placing the sheet metal layer with its periphery in contact with the surrounding surface of the first portion; and
forming a co-extensive, ultrasonically welded bond between the periphery of the sheet metal layer and the surrounding surface of the first portion, circumscribing the applied vibration damping material so that the vibration damping material is held in interfacial engagement with the entire selected surface area of the first portion of the vibratile element structure of the article.

2. A method of making an article of manufacture as recited in claim 1 in which the first portion of the vibratile element structure is formed of an aluminum alloy and the sheet metal layer covering the vibration damping material is made of an aluminum alloy compatible with the first portion of the vibratile element structure.

3. A method of making an article of manufacture as recited in claim 1 in which the first portion of the vibratile element structure is formed of a magnesium alloy and the sheet metal layer covering the vibration damping material is made of a magnesium alloy compatible with the first portion of the vibratile element structure.

4. A method of making an article of manufacture as recited in claim 1 in which the first portion of the vibratile element structure is formed of a steel alloy and the sheet metal layer covering the vibration damping material is made of a steel alloy compatible with the first portion of the vibratile element structure.

5. A method of making an article of manufacture as recited in claim 1 in which the vibration damping material comprises a layer formed of a metal composition compatible with the surface area of the first portion of the vibratile element structure and the vibration damping material is adapted for coulomb damping interfacial engagement with the surface area of the first portion of the vibratile element structure.

6. A method of making an article of manufacture as recited in claim 5 in which a stack of coulomb vibration damping material layers is applied consisting of individual layers, each having thicknesses in the range of about fifty micrometers to about five hundred micrometers.

7. A method of making an article of manufacture as recited in claim 5 in which the thickness of the coulomb damping material is in the range of about fifty micrometers to about two thousand micrometers.

8. A method of making an article of manufacture as recited in claim 1 in which the vibration damping material comprises a layer formed of a polymer composition compatible with the surface area of the first portion of the vibratile element structure and the vibration damping material is adapted for viscous damping interfacial engagement with the surface area of the first portion of the vibratile element structure.

9. A method of making an article of manufacture as recited in claim 8 in which the thickness of the viscous vibration damping material applied is in the range of about twenty-five micrometers to about one thousand micrometers.

10. A method of making an article of manufacture as recited in claim 1 in which the depth of a recessed surface area for receiving at least one layer of vibration damping material is up to about one thousand micrometers.

11. A method of making an article of manufacture as recited in claim 1 in which the thickness of the sheet metal covering layer is up to about three hundred micrometers.

12. A method of making an article of manufacture as recited in claim 1 in which more than one surface area, or recessed surface area, of the article of manufacture are selected and each selected area receives at least one layer of vibration damping material, and the vibration damping material in each such surface area is covered and confined with a sheet metal layer, and the periphery of each such covering layer is ultrasonically welded to the adjacent surrounding surface of the article.

13. An article of manufacture comprising one or more structural elements in which at least one of its structural elements is found or determined to produce or transmit mechanical vibrations in use of the article, the vibratile structural element being made of a metallic composition; the vibratile structural element comprising a surface region carrying at least one layer of vibration damping material confined against the surface region with a metal sheet layer that covers the vibration damping material and has peripheral edges that are ultrasonically welded to the periphery of the surface region.

14. An article of manufacture as recited in claim 13 in which the vibration damping material comprises a layer formed of a metal composition compatible with the surface area of the first portion of the vibratile element structure and the vibration damping material is adapted for coulomb damping interfacial engagement with the surface area of the first portion of the vibratile element structure.

15. An article of manufacture as recited in claim 14 comprising coulomb damping material having a thickness up to about two thousand micrometers and confined against the surface region with a metal sheet layer that covers the vibration damping material and has peripheral edges that are ultrasonically welded to the periphery of the surface region.

16. An article of manufacture as recited in claim 13 in which the vibration damping material is adapted for viscous damping interfacial engagement with the surface area of the first portion of the vibratile element structure.

17. An article of manufacture as recited in claim 16 in which the vibration damping material comprises a layer formed of a polymer composition compatible with the surface area of the first portion of the vibratile element structure and the vibration damping material is adapted for viscous damping interfacial engagement with the surface area of the first portion of the vibratile element structure.

18. An article of manufacture as recited in claim 16 comprising viscous damping polymeric material having a thickness up to about two thousand micrometers and confined against the surface region with a metal sheet layer that covers the vibration damping material and has peripheral edges that are ultrasonically welded to the periphery of the surface region.

19. An article of manufacture as recited in claim 13 in which the thickness of the vibration damping material in the selected area is up to about 2000 micrometers and the thickness of the covering metal sheet layer is up to about three hundred micrometers.

20. An article of manufacture as recited in claim 13 comprising more than one surface region carrying at least one layer of vibration damping material, and the vibration damping material in each such surface region is covered and confined with a sheet metal layer, and the periphery of each such covering layer is ultrasonically welded to the adjacent surrounding surface of the article.
